(19) United States
(12) Patent Application Publication
(10) Pub. No.: US 2016/0120172 A1
(43) Pub. Date: May 5, 2016

(54) Cryopreservation device for biological material

(71) Applicant: CRYOGENETICS AS, Hamar (NO)

(72) Inventors: Inger Grevle, Hamar (NO); Katarina Ruud, INGEBERG (NO)

(21) Appl. No.: 14/893,545

(22) PCT Filed: May 28, 2014
(86) PCT No.: PCT/EP2014/061143

§ 371 Date: Nov. 24, 2015

(30) Foreign Application Priority Data
May 30, 2013 (NO) 20130752

(51) Int. Cl. A01N 1/02

(52) U.S. Cl. CPC A01N 1/0242; A01N 1/021

(57) ABSTRACT

A cryopreservation device for biological material comprises an outer tube (11) closed in both ends, an inner tube (12) arranged to be filled with the biological material, closed in both ends, and located in the outer tube, and at least one weight element (14) arranged inside the outer tube and outside the inner tube.

The present invention relates to a cryopreservation device for biological material, for example for storing, transport and/or freezing of a biological material. More particular, the invention regards a device for cryopreservation of spermatozoa, embryos or eggs from aquatic organisms.

Traditionally, semen or milt are cryopreserved in cryogenic straw consisting of a narrow and slender tube as for example disclosed in EP 0 873 726 A1, EP 0,562,947 A1, U.S. Pat. No. 5,868,178, and U.S. Pat. No. 5,190,880.

Holding of frozen samples in liquid nitrogen (−196° C.) in a storage dewar is a standard method for cryogenic storage of samples from aquarium fishes. During storage, important considerations are identification, potential contamination, and inventory of frozen samples. The use of plastic or French straws for packaging, especially the newer forms with high safety and durability, offers the advantages of permanent labeling by printer, and complete sealing of the straws which minimizes or prevents transfer of materials (e. g. sperm cells or bacteria) among samples stored in the same dewar (Morris, 2005).

When cryopreserving very small amounts, the straws must also be small in order to secure a stable and predicable freezing progress. This complicates both handling and labeling of the straws.

US 2011196358 describes a device for vitrification of human cells or non-human cells. A micro-capillary of quartz is arranged in an outer protective sheath. The outer protective sheath protects the micro-capillary from contamination during storage after the content of the micro-capillary has been vitrified. A weight element is connected to one end of the outer sheath in order to enhance the orientation of the device during storage in liquid.

US 2008/0233633 describes a sheathing for packaging a predetermined volume of a biological substance intended to be immersed in a liquid cryogenic agent for vitrification. The biological substance is arranged in the sheathing by means of a support with a small reception area for the biological substance to be exposed to the cold environment when the sheathing is lowered to the cryogenic agent.

The object of the invention is to provide a cryopreservation device and a method for assembling a cryopreservation device for biological material which is suitable for freezing and cryopreserving small volumes, while ensuring a preferable freezing curve of the whole content.

The object of the invention is achieved by means of the features of the patent claims.

A cryopreservation device for biological material comprises in one embodiment an outer tube closed in both ends, an inner tube arranged to be filled with the biological material, closed in both ends, and located in the outer tube, and at least one weight element arranged inside the outer tube and outside the inner tube.

The biologic material is for example semen, embryos, eggs, etc. The invention is particularly suitable for cryopreservation small volumes of biological material from aquatic species. Aquatic species are in this context any organism living in water and wherein reproduction is performed by the joining of spermatozoa and egg from a male and female animal, respectively, herein organisms employing oviparous, ovoviviparous or viviparous reproduction. The present invention allows packaging of seamen or milt from marine, anadromous and fresh water fish. However, the invention is not limited to fish species, but also includes other water-dwelling organisms such as Crustacea, inter alia crabs, lobsters, crayfish, shrimps, shellfish and barnacles, and Mollusca, inter alia gastropods such as abalone, cephalopods such as octopus, and bivalves such as scallops, clams and oysters.

Non-limiting examples of oviparous fish species are inter alia Salmonidae, such as Atlantic salmon (Salmo salar L.) and rainbow trout (Onchorhyncus mykiss), Gadidae, such as Atlantic cod (Gadus morhua) and haddock (Melanogrammus aeglefinus) and Cichlidae, such as Nile tilapia (Oreochromis niloticus niloticus). Non-limiting examples of ovoviviparous fish include inter alia Poecilidae, such as guppy (Poecilia reticulata) and Squatinidae, such as angel sharks (Squatina spp.). Non-limiting examples of viviparous fishes includes coelacanths (Latimeria chalumnae), Goodeidae (splitfins), Embiotocidae (surf-perches) and Carcharhinidae (requiem sharks).

The invention can also be used for cryopreservation of small volumes of biological material from other species than aquatic species, for example in those cases where there is need for cryopreservation of microvolumes.

The inner tube is for example a micro straw or other similar tubular device with a small volume. In one embodiment the inner tube has a volume of less than 250 μl, in another embodiment the volume of the inner tube is less than 100 μl but other volumes are also possible. The inner tube may be produced with one closed end or with two open ends. In the latter embodiment, one end may be closed prior to insertion of the prepared biological material, e.g. diluted zebra fish milt, and the second end is then closed after insertion. Alternatively the biological material is inserted into the inner tube and centered in the inner tube before the tube is closed in both ends. In all embodiments both ends are closed after the biological material is arranged inside the inner tube.

The closing may be done by means of a sealant, for example a glazing compound such as glazing putty, an adhesive, cement, filler, glue or lute. The sealant must however tolerate storage in low temperatures over time without leakage. The inner tube may also be closed by means of welding or by means of a sealing ball.

The outer tube must have an inner diameter which exceeds the outer diameter of the inner tube. In one embodiment the outer tube has a volume of 0.5 ml. The volume of the outer tube may in other embodiments have volumes up to 2.5 ml or larger. The volume of the outer tube may be adapted to the volume of the inner tube. As the outer tube has larger volume than the inner tube, there will be an air layer between the inner tube and the outer tube which insulates against the cryogenic fluid/coolant in which the device is submersed. The thickness of this air layer will influence on the freezing curve (temperature vs. time) for the biological material, and the ratio of the sizes of the outer/inner tube, such as ratio of diameter and/or length of the tubes, may be chosen to provide the desired freezing curve, and may depend on the need for a desired freezing curve and/or a stable freezing curve.

Similar to the inner tube, the outer tube may be closed in one or none of its ends before the inner tube is inserted into the outer tube. The outer tube may be closed by means of welding or/and by means of a sealant. The sealant may be any of the sealants described above for closing the inner tube. In one embodiment one end is closed by welding, while the second end is closed by means of a sealant or a sealing ball.

The material of the outer tube must tolerate to be immersed in a liquid cryogenic agent and withstand being stored in a liquid cryogenic agent over time.

The at least one weight element is arranged inside the outer tube before closing the outer tube. The weight element may be an elongated element with diameter less than the inner diameter of the outer tube or may have another shape such as spherical. The weight element may have a diameter which is larger than the air space between the outer tube and the inner tube to prevent unwanted displacement of the weight element. In one embodiment there is one weight element arranged in one end of the outer tube. In another embodiment there is two weight element arranged in opposite ends of the outer tube. There may also be more than one weight element in one or both ends of the outer tube in order to obtain a desired weight. For example may a sealing ball, which seals the outer tube, constitute the weight element and there may be additional sealing balls inserted in the outer tube to achieve the desired weight. The weight of the weight element should be larger than the buoyancy of the device in the coolant, in order to maintain a submerged position of the device during freezing and storage.

The invention will now be described in more detail by means of an example, and with reference to the accompanying FIGURE.

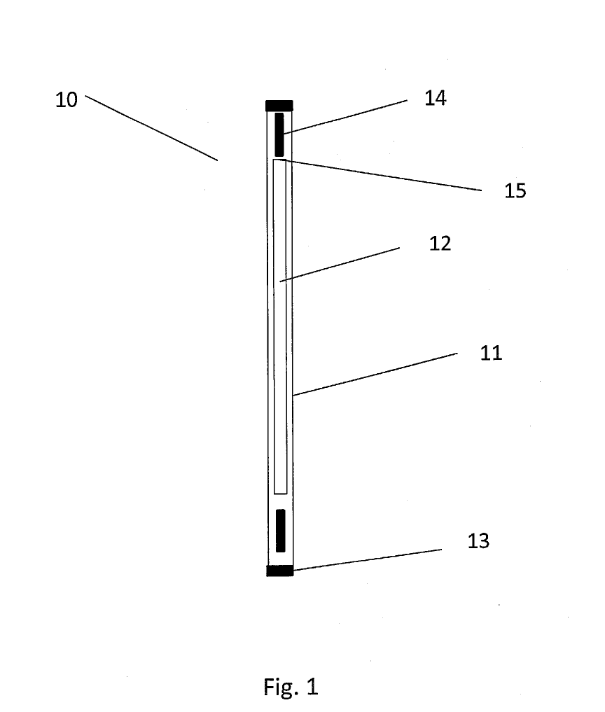

FIG. 1 shows schematically an embodiment of the invention.

In FIG. 1, the cryopreservation device 10 for biological material is shown in assembled state. The cryopreservation device 10 comprises an outer tube 11 closed in both ends by means of sealant 13, an inner tube 12 filled with the biological material (not shown), closed in both ends by means of a sealant 15, and located in the outer tube. The device 10 further comprises two weight elements 14 arranged inside the outer tube and outside the inner tube.

The outer tube 11 may for example be a medium straw of 0.5 ml, while the inner tube may be a micropipette.

1. Cryopreservation device for biological material, comprising
an outer tube closed in both ends,
an inner tube arranged to be filled with the biological material, closed in both ends, and located in the outer tube,
at least one weight element arranged inside the outer tube and outside the inner tube.

2. Device according to claim 1, where the inner tube has a volume of less than 100 μl.

3. Device according to claim 1, where the inner tube has a volume of less than 250 μl.

4. Device according to claim 1, comprising two weight elements arranged in opposite ends of the outer tube.

5. Device according to claim 1, where the outer tube is closed by means of welding.

6. Device according to claim 1, where the outer tube is closed by means of a sealant.

7. Device according to claim 1, where the inner tube is closed by means of a sealant.

8. Device according to claim 1, where the inner tube is closed by means of welding.

9. (canceled)

10. Kit for cryopreservation of biological material comprising an outer tube, an inner tube adapted for fitting inside the outer tube, and at least one weight element adapted for fitting inside the outer tube and outside the inner tube.

11. A method for cryopreservation of biological material, comprising the steps of:
a. providing a cryopreservation device according to one of claims 1-4,
b. inserting a volume of biological material in the inner tube,
c. sealing the inner tube,
d. inserting the inner tube inside the outer tube,
e. sealing the outer tube,
f. immersing the cryopreservation device in a liquid cryogenic agent.

12. The method according to claim 11, wherein the biological material is selected from the group consisting of semen, eggs and embryos.

13. The method according to claim 12, wherein the biological material is from an aquatic species of organism.

14. The method according to claim 11, wherein the cryopreservation agent is liquid nitrogen.

15. The method according to claim 11, wherein the weight of the weight element is larger than the buoyancy of the cryopreservation device in the cryopreservation agent, whereby the device will remain submerged in the liquid.
